(19) United States
(12) Patent Application Publication
(10) Pub. No.: US 2021/0054862 A1
(43) Pub. Date: Feb. 25, 2021

(54) LATERAL POSITIONING DEVICE

(71) Applicant: FIVETECH TECHNOLOGY INC., NEW TAIPEI CITY (TW)

(72) Inventor: TING-JUI WANG, NEW TAIPEI CITY (TW)

(21) Appl. No.: 17/092,596

(22) Filed: Nov. 9, 2020

Related U.S. Application Data
(62) Division of application No. 16/251,179, filed on Jan. 18, 2019.
Application No. 16/251,179 is a continuation-in-part of application No. 15/197,986, filed on Jun. 30, 2016, now Pat. No. 10,378,568.

(30) Foreign Application Priority Data
Jul. 3, 2015 (TW) 104210851

(51) Int. Cl. F16B 5/02; F16B 5/06

(52) U.S. Cl. CPC F16B 5/0266; F16B 5/065

(57) ABSTRACT

A lateral positioning device coupled to a first object to laterally engage or interfere with a second object. The lateral positioning device includes a body portion and positioning element. The body portion is coupled to the first object in a first direction and has a through hole which has therein a limiting portion and extends in a second direction, with an angle formed between the first and second directions. The positioning element is penetratingly disposed in the through hole and limited by the limiting portion to thereby move in the second direction. The positioning element has an engaging portion disposed on the first side of the limiting portion to allow the engaging portion to engage with the second object; a stopping portion disposed on the second side of the limiting portion; and a neck portion connecting with the engaging and stopping portions and passing through the limiting portion.

### CROSS-REFERENCE TO RELATED APPLICATION

This application is a divisional patent application of U.S. application No. Ser. 16/251,179 filed on Jan. 18, 2019, which is a CIP of U.S. application Ser. No. 15/197,986 filed on Jun. 30, 2016, now U.S. Pat. No. 10,378,568 issued Aug. 13, 2019, which claims priority to Taiwanese Patent Application No.104210851 filed on Jul. 3, 2015, the entire contents all of which are hereby incorporated by reference.

### BACKGROUND OF THE INVENTION

### 1. Field of the Invention

The present invention relates to lateral positioning devices and, more particularly, to a lateral positioning device coupled to a first object and engaged, quickly as well as laterally, with a second object.

### 2. Description of the Related Art

According to the prior art, two parallel plates can be connected by a fixedly connecting component. The fixedly connecting component usually operates by screwing and comprises a screw and a sleeve. One end of the screw has a driven portion that comes with a drive. The other end of the screw has a threaded portion connected to the driven portion. The sleeve fits around the threaded portion of the screw so that the screw can move within the sleeve. Therefore, the fixedly connecting component operates in a manner described below. One end of the sleeve gets coupled to a first object (such as a circuit board), whereas the threaded portion of the screw penetrates one end of the sleeve and corresponds in position to a locking hole of a second object (such as a chassis or a casing), and then a tool exerts a rotational force on the drive of the driven portion of the screw to fasten the threaded portion to the locking hole of the second object, thereby connecting the parallel first and second objects.

However, the fixedly connecting component fails to connect, screw together, or engage two objects which are perpendicular to each other, for example, in the situation where the first object is fixed in place on a plane which extends in direction X, whereas the second object is fixed in place on a plane which extends in direction Y, wherein direction Y is perpendicular to direction X. Therefore, it is important to provide a positioning-engaging device for connecting two objects which are perpendicular to each other and enabling the two objects to be quickly connected and separated by pressing, engagement or twisting without a tool.

### BRIEF SUMMARY OF THE INVENTION

In view of the aforesaid drawbacks of the prior art, the inventor of the present invention conceived room for improvement in the prior art and thus conducted extensive researches and experiments according to the inventor's years of experience in the related industry, and finally developed a lateral positioning device as disclosed in the present invention to quickly connect two non-parallel objects, and achieve structural simplicity, so as to render operation quick and convenient.

In order to achieve the above and other objectives, the present invention provides a lateral positioning device, comprising: a body portion adapted to be coupled to a first object in a first direction and having a through hole which has therein a limiting portion and extends in a second direction, with an angle formed between the first direction and the second direction; and a positioning element penetratingly disposed in the through hole and limited by the limiting portion to thereby move in the second direction, wherein the positioning element has an engaging portion for engaging or interfering with a second object.

Regarding the lateral positioning device, the body portion is a post, a cylinder, a rod, a block, a plate, a hollowed-out structure, a bent structure, a polyhedral structure, an irregularly shaped solid structure, a handle structure or a latch structure.

Regarding the lateral positioning device, the body portion has a shoulder for abutting against the first object.

Regarding the lateral positioning device, the body portion has a jointing portion adapted to be coupled to the first object in the first direction through a post-connecting structure, a riveting structure, a screwing structure, an expanding structure, a welding structure, a snap-engaging structure, an adhering structure, a magnetically attracting structure or an integrally formed structure.

Regarding the lateral positioning device, the engaging portion of the positioning element is disposed on a first side of the limiting portion, wherein the positioning element has a stopping portion and a neck portion, with the stopping portion disposed on a second side of the limiting portion, and the neck portion connected to the engaging portion and the stopping portion and adapted to pass through the limiting portion.

Regarding the lateral positioning device, an angle of 30°˜150° is formed between the first direction and the second direction.

Regarding the lateral positioning device, the engaging portion of the positioning element is a post, a threaded structure, a female engaging structure, a resiliently engaging structure, a spherical structure, a male engaging structure, an arcuate-surfaced structure or an oblique-surfaced structure.

Regarding the lateral positioning device, the stopping portion is disposed inside or outside the through hole.

Regarding the lateral positioning device, at least one of the first side and the second side of the limiting portion of the through hole forms a retraction space, and the engaging portion or the stopping portion of the positioning element is received or moves within in the retraction space.

The lateral positioning device further comprises a resilient element with an end abutting against the engaging portion and another end abutting against the limiting portion or the body portion, or with an end abutting against the stopping portion and another end abutting against the limiting portion or the body portion, thereby allowing the engaging portion to engage or interfere with the second object resiliently.

Regarding the lateral positioning device, two limiting portions are disposed on an inner wall of the through hole or disposed at openings at two ends of the through hole, respectively, and the stopping portion is received in the through hole between the limiting portions.

The lateral positioning device further comprises a resilient element with an end abutting against the body portion or any one of the limiting portions and another end abutting against the stopping portion.

Regarding the lateral positioning device, the resilient element is a helical spring, a resilient post or a leaf spring.

The lateral positioning device and the first object are mounted together or form integrally a module.

Regarding the lateral positioning device, the retraction space is a cylindrical space, a hexahedral space, a conical space, an arcuate space, a stepped space, a chamber-style space, an open chamber-style space, a recess, an L-shaped chamber or a one-sided chamber.

Regarding the lateral positioning device, the positioning element has at one end thereof an operating portion.

Regarding the lateral positioning device, the operating portion has a color layer, and the color layer is made of plastic, rubber, silica gel, lacquer, baking varnish or electroplated layer.

Regarding the lateral positioning device, the through hole is a cylindrical space, a hexahedral space, a conical space, an arcuate space, a stepped space, a chamber-style space, an open chamber-style space, a recess, an L-shaped chamber or a one-sided chamber.

Regarding the lateral positioning device, the body portion is adapted to be coupled to the first object in the first direction through a sleeve movably disposed at the body portion.

The present invention further provides a lateral positioning device, comprising: a body portion adapted to be coupled to a first object in a first direction and having a chamber portion which has therein a limiting portion and extends in a second direction, with an angle formed between the first direction and the second direction; and a movement element penetratingly disposed in the chamber portion and limited by the limiting portion to thereby move in the second direction.

Regarding the lateral positioning device, one end of the movement element has an engaging portion, and the engaging portion engages or interferes with a second object.

Regarding the lateral positioning device, one end of the movement element has an operating portion.

Regarding the lateral positioning device, the operating portion is disposed inside or outside the chamber portion.

Regarding the lateral positioning device, the operating portion is a post-shaped, sheet-shaped, convex, concave, arcuate, spherical, taper, handle-shaped or movable board.

Regarding the lateral positioning device, the movement element has a movement opening, and the limiting portion is confined to the movement opening.

Regarding the lateral positioning device, the limiting portion is a penetratingly disposing element, and the penetratingly disposing element is movably penetratingly disposed or fixedly penetratingly disposed in the movement opening.

Regarding the lateral positioning device, the movement opening is a through hole, a recess, an oblong slot or an oblong hole.

Regarding the lateral positioning device, the movement element moves within a movement limiting space of the movement opening.

Regarding the lateral positioning device, the body portion has a body portion opening, and the limiting portion is confined to the body portion opening.

Regarding the lateral positioning device, the limiting portion is a penetratingly disposing element, and the penetratingly disposing element is movably penetratingly disposed or fixedly penetratingly disposed in the body portion opening.

Regarding the lateral positioning device, the body portion opening is a through hole, a recess, an oblong slot or an oblong hole.

Regarding the lateral positioning device, the movement element moves within a movement limiting space of the body portion opening.

Regarding the lateral positioning device, the penetratingly disposing element is integrally formed of a post, an engaging structure or a plate and a body portion or a movement element.

The lateral positioning device further comprises a resilient element with two ends abutting against the movement element and the limiting portion, respectively, from inside or outside, or against the movement element and the body portion, respectively, from inside or outside.

Regarding the lateral positioning device, the chamber portion is a through hole, a recess, an L-shaped chamber or a one-sided chamber.

Regarding the lateral positioning device, the body portion or the movement element is made of a plastic or a metal.

Regarding the lateral positioning device, the lateral positioning device and the first object together form a module.

The lateral positioning device comprises a carrier for carrying the lateral positioning device.

Regarding the lateral positioning device, the carrier is a feed pan or a feed belt.

Regarding the lateral positioning device, the carrier has a lid for covering the lateral positioning device.

Regarding the lateral positioning device, the first object is made of a printed circuit board (PCB) plastic or a metal.

Regarding the lateral positioning device, the first object or the second object is a printed circuit board (PCB), and the lateral positioning device is mounted on the first object before laterally engaging or interfering with the second object.

Regarding the lateral positioning device, a conduction circuit point is disposed between the lateral positioning device and the first object or the second object, connected to a conduction circuit portion, and adapted to guide an electric charge or an electric current.

Regarding the lateral positioning device, the lateral positioning device is mounted on the first object before laterally engaging with a second object, so as to confine the second object to between an engaging portion of the movement element and a shoulder of the body portion.

Regarding the lateral positioning device, the body portion has a blocking-engaging portion and at least one resilient opposing portion, the blocking-engaging portion being coupled to the first object, and the resilient opposing portion resiliently opposing the first object such that the first object is resiliently engaged between the blocking-engaging portion and the resilient opposing portion.

Regarding the lateral positioning device, the blocking-engaging portion and the resilient opposing portion oppose each other in identical or different directions to thereby vertically engage with the first object, or the blocking-engaging portion vertically penetrates the first object before being rotated to thereby rotatably engage with the first object.

Regarding the lateral positioning device, the body portion has a blocking-engaging portion penetrating a joined portion of the first object and then rotates by 5 degrees ˜355 degrees to thereby interfere with, engage with or oppose the first object.

Regarding the lateral positioning device, the body portion has a corresponding fitting portion, and the movement element has a fitting portion, such that the fitting portion resiliently engages with or is resiliently engaged with the corresponding fitting portion.

Regarding the lateral positioning device, the fitting portion or the corresponding fitting portion is an oblique surface, an arcuate surface or a curved surface.

Regarding the lateral positioning device, the body portion and the movement element are independent of each other and each formed by solidification of a liquid raw material introduced into a mold by in-mold injection.

Regarding the lateral positioning device, the body portion and the movement element are connected by a connecting portion so as to be integrally formed and are each formed by solidification of a liquid raw material introduced into a mold by in-mold injection.

Regarding the lateral positioning device, the resilient element and the body portion or the movement element are integrally formed, and the integrally-formed resilient element is formed by solidification of a liquid raw material introduced into a mold by plastic in-mold injection.

Regarding the lateral positioning device, the body portion has a corresponding fitting portion, and the movement opening has a fitting portion, such that the fitting portion fits to or is fitted to the corresponding fitting portion, thereby allowing the body portion and the movement opening to movably fit together.

Regarding the lateral positioning device, the movement element is limited by the limiting portion and rotatably disposed at the chamber portion.

Regarding the lateral positioning device, the limiting portion has a resilient element with two ends abutting against the body portion and the movement element, respectively.

Regarding the lateral positioning device, the body portion has a weldable surface and is taken out of a carrier by a vacuum suction tool or a tool and then placed on a weldable surface of a second object or a first object such that the weldable surface of the body portion and the weldable surface of the second object or the first object are welded together.

Regarding the lateral positioning device, the body portion in a first direction thereof has an engaging structure coupled to an engaging hole of the first object and larger than the engaging hole.

Regarding the lateral positioning device, the body portion in a first direction thereof has an engaging structure coupled to an engaging hole of the first object and larger than the engaging hole such that the engaging structure contracts when entering the engaging hole and expands after passing through the engaging hole.

Regarding the lateral positioning device, the body portion has a positioning portion positioned at the first object.

Regarding the lateral positioning device, the movement element has a convoluted surface.

Regarding the lateral positioning device, the first object is a printed circuit board.

Regarding the lateral positioning device, the movement element has a convex structure, a concave structure or a stepped anti-skid structure, or the movement element has an operating portion, the operating portion being a convex structure, a concave structure or a stepped anti-skid structure, or the operating portion being a wing-shaped structure, a hook-shaped structure, a post-shaped structure, an arcuate structure, an oblique surface structure, a stepped structure or a planar structure.

Regarding the lateral positioning device, the first object is a printed circuit board, and the movement element engages or interferes with the second object.

The lateral positioning device further comprises a resilient element for abutting against the movement element and the limiting portion, such that the movement element or the body portion has a movement opening, so as for the limiting portion or the resilient element to be confined to the movement opening, such that the resilient element is confined to between the movement element and the body portion while moving abuttingly.

Regarding the lateral positioning device, the movement element engages with the body portion.

Regarding the lateral positioning device, the movement element has thereon a convex structure, a concave structure or a stepped anti-skid structure, or the movement element has an operating portion, the operating portion being wing-shaped, post-shaped, sheet-shaped, convex, concave, arcuate, spherical, conical or handle-shaped or being a movable plate.

Regarding the lateral positioning device, the first object is a printed circuit board, a metal plate or a plastic plate, whereas the movement element engages with or interferes with a second object, the second object being a printed circuit board, a metal plate or a plastic plate.

The lateral positioning device further comprises a resilient element, and the resilient element is confined to between the movement element and the body portion when abutting against the chamber portion from inside.

Regarding the lateral positioning device, the movement element and the body portion engage with each other to fit together, resiliently engage with each other to fit together or are resiliently engaged with each other to fit together.

Regarding the lateral positioning device, after being taken out of a carrier by a tool, the lateral positioning device is compared by a comparison device to compare or calculate a relative or absolute position and distance between the lateral positioning device and a plate and then provide the tool with related information to allow the tool to place the lateral positioning device at a target position on the first object precisely.

Regarding the lateral positioning device, the tool is a vacuum sucker, a magnetic sucker or a clamp, the comparison device is a visual comparison device, an image comparison device or a distance calculating device, and the first object is a printed circuit board (PCB), a metal plate or a plastic plate.

Regarding the lateral positioning device, the engaging portion has a guidance portion which retreats under a pressing force exerted by the second object on the guidance portion such that the second object enters a space between the engaging portion and a shoulder of the body portion, thereby allowing the second object to be confined to between the engaging portion and the shoulder.

Regarding the lateral positioning device, the joined portion of the first object is a wide-hole portion, and a wide side of the blocking-engaging portion penetrates the first object from a wide side of the wide-hole portion and then rotates such that the wide side of the blocking-engaging portion rotates to the non-wide side position of the wide-hole portion so as to perform opposition.

Regarding the lateral positioning device, the joined portion of the first object is a wide-hole portion, and the resilient opposing portion rotates from a non-wide side or a wide side of the wide-hole portion to the wide side or the non-wide side of the wide-hole portion so as to oppose a surface of the first object.

Regarding the lateral positioning device, the joined portion of the first object has a wide-hole portion, and the resilient opposing portion has a blocking-engaging portion, the blocking-engaging portion rotating from a non-wide side or a wide side of the wide-hole portion to the wide side or the non-wide side of the wide-hole portion to oppose the wide-hole portion from inside or outside, so as to limit a position of the resilient opposing portion.

Regarding the lateral positioning device, the body portion has a blocking-engaging portion, whereas an axial portion is disposed between the blocking-engaging portion and the body portion and has a wide portion smaller than the wide side of the blocking-engaging portion and smaller than the joined portion or a wide-hole portion of the first object.

Regarding the lateral positioning device, the movement element has a guidance portion which retreats under a pressing force exerted by the second object on the guidance portion such that the second object enters a space between the movement element and the body portion, thereby allowing the second object to be confined to between the movement element and the body portion.

Regarding the lateral positioning device, the body portion has a positioning portion positioned at the first object to allow the body portion to be positioned at the positioning portion when joined to the first object by the jointing portion, such that the body portion has two transverse limiting structures, namely the jointing portion and the positioning portion, for preventing rotation of the body portion.

Regarding the lateral positioning device, a plate is inserted into the jointing portion of the body portion to undergo welding, or the jointing portion of the body portion is a welding surface to be welded to the plate surface.

Regarding the lateral positioning device, the body portion and the movement element are connected by a fastening portion, and the fastening portion is bent to assemble the body portion and the movement element.

Therefore, the lateral positioning device of the present invention is characterized in that: the body portion is coupled to the first object in the first direction X, and the positioning element faces the second direction Y to squarely engage or laterally interfere with the second object, thereby connecting the first object and the second object laterally and quickly.

### BRIEF DESCRIPTION OF THE DRAWINGS

FIG. 1 is a cross-sectional schematic view of a lateral positioning device according to the first preferred embodiment of the present invention.

FIG. 2 is a perspective view of the lateral positioning device according to the first preferred embodiment of the present invention.

FIG. 3 is a cross-sectional schematic view of lateral interference operation of the lateral positioning device according to the first preferred embodiment of the present invention.

FIG. 4 is a cross-sectional schematic view of movement of a positioning element of the lateral positioning device according to the first preferred embodiment of the present invention.

FIG. 5 is a cross-sectional schematic view of lateral interference state of the lateral positioning device according to the first preferred embodiment of the present invention.

FIG. 6 is a cross-sectional schematic view of the lateral positioning device according to the second preferred embodiment of the present invention.

FIG. 7 is a cutaway view of the lateral positioning device according to the second preferred embodiment of the present invention.

FIG. 8 is a cross-sectional schematic view of squarely engagement state of the lateral positioning device according to the second preferred embodiment of the present invention.

FIG. 9 is a cross-sectional schematic view of disengagement of the lateral positioning device according to the second preferred embodiment of the present invention.

FIG. 10 is a cross-sectional schematic view of the lateral positioning device according to the third preferred embodiment of the present invention.

FIG. 11 is a cross-sectional schematic view of how the lateral positioning device is screwed to a second object according to the third preferred embodiment of the present invention.

FIG. 12 is a cross-sectional schematic view of limiting portions disposed at two ends of a through hole, respectively, according to the present invention.

FIG. 13 is a cross-sectional schematic view of use of the limiting portions disposed at two ends of the through hole, respectively, according to the present invention.

FIG. 14 is a schematic view of a resilient element provided in the form of a helical spring according to the present invention.

FIG. 15 is a schematic view of the resilient element provided in the form of a resilient post according to the present invention.

FIG. 16 is a schematic view of the resilient element provided in the form of a leaf spring according to the present invention.

FIG. 17 is a schematic view which shows that an engaging portion of the positioning element is provided in the form of a post according to the present invention.

FIG. 18 is a schematic view which shows that the engaging portion of the positioning element is provided in the form of a threaded structure according to the present invention.

FIG. 19 is a schematic view which shows that the engaging portion of the positioning element is provided in the form of a female engaging structure according to the present invention.

FIG. 20 is a schematic view which shows that the engaging portion of the positioning element is provided in the form of a resiliently engaging structure according to the present invention.

FIG. 21 is a schematic view which shows that the engaging portion of the positioning element is provided in the form of a spherical structure according to the present invention.

FIG. 22 is a schematic view which shows that the engaging portion of the positioning element is provided in the form of an arcuate-surfaced structure according to the present invention.

FIG. 23 is a cross-sectional schematic view of the lateral positioning device according to the fourth preferred embodiment of the present invention.

FIG. 24 is a cross-sectional schematic view of assembly and engagement of the lateral positioning device according to the fifth preferred embodiment of the present invention.

FIG. 25 is a cross-sectional schematic view of assembly and disengagement of the lateral positioning device shown in FIG. 24.

FIG. 26 is a cross-sectional schematic view of assembly and engagement of the lateral positioning device shown in FIG. 24.

FIG. 27 is a top view of the assembly framework of the lateral positioning device shown in FIG. 24.

FIG. 28 is a cross-sectional schematic view of a body portion provided in the form of a cylinder according to the fifth preferred embodiment of the present invention.

FIG. 29 is a top view of the assembly framework of the body portion shown in FIG. 28.

FIG. 30 is a cross-sectional schematic view of a movement opening of a movement element and the limiting portion according to another preferred embodiment of the present invention.

FIG. 31 is a top view of the assembly framework shown in FIG. 30.

FIG. 32 is a cross-sectional schematic view of a body portion opening of the body portion and the limiting portion according to another preferred embodiment of the present invention.

FIG. 33 is a top cross-sectional schematic view of the assembly framework shown in FIG. 32.

FIG. 34 is a cross-sectional schematic view which shows that an operating portion of the movement element is a movable board.

FIG. 35 is a cross-sectional schematic view of the operation of the operating portion shown in FIG. 34.

FIG. 36 is a schematic view which shows that the engaging portion of the movement element is a threaded structure.

FIG. 37 is a schematic view which shows that the engaging portion of the movement element is a female engaging structure.

FIG. 38 is a schematic view which shows that the engaging portion of the movement element is a male engaging structure.

FIG. 39 is a cross-sectional schematic view which shows that a chamber portion of the body portion is a penetrating opening.

FIG. 40 is a cross-sectional schematic view which shows that the chamber portion of the body portion is a recess.

FIG. 41 is a cross-sectional schematic view which shows that the chamber portion of the body portion is an L-shaped chamber or a one-sided chamber.

FIG. 42 is a cross-sectional schematic view of the lateral positioning device according to the six preferred embodiment of the present invention.

FIG. 43 is a cross-sectional schematic view of assembly and engagement of the lateral positioning device shown in FIG. 42.

FIG. 44 is a cross-sectional schematic view of assembly of the lateral positioning device shown in FIG. 42 and from another direction.

FIG. 45 is a cross-sectional schematic view of the lateral positioning device shown in FIG. 42, applied to a first object, and engaged with the second object.

FIG. 46 is a schematic view of the lateral positioning device provided in the form of a handle structure or a latch structure according to the present invention.

FIG. 47 is a schematic view of the lateral positioning device loaded with a carrier according to an embodiment of the present invention.

FIG. 48 is an assembled cross-sectional schematic view of the seventh preferred embodiment of the present disclosure.

FIG. 49 is an assembled schematic view of the eighth preferred embodiment of the present disclosure and the first object.

FIG. 50 is an assembled schematic view of the ninth preferred embodiment of the present disclosure and the first object.

FIG. 51 is an assembled schematic view of the tenth preferred embodiment of the present disclosure.

FIG. 52 is a schematic view of the eleventh preferred embodiment of the present disclosure.

FIG. 53 is a schematic view of in-mold injection of the eleventh preferred embodiment of the present disclosure.

FIG. 54 is a schematic view of the twelfth preferred embodiment of the present disclosure.

FIG. 55 is a schematic view of the thirteenth preferred embodiment of the present disclosure.

FIG. 56 is a schematic view of operation of the thirteenth preferred embodiment of the present disclosure.

FIG. 57 is a schematic view of operation of the fourteenth preferred embodiment of the present disclosure.

FIG. 58 is a schematic view of the fifteenth preferred embodiment of the present disclosure.

FIG. 59 is a schematic view 1 of operation of the fifteenth preferred embodiment of the present disclosure.

FIG. 60 is a schematic view 2 of operation of the fifteenth preferred embodiment of the present disclosure.

FIG. 61 is a schematic view 3 of operation of the fifteenth preferred embodiment of the present disclosure.

FIG. 62 is a schematic view 1 of operation of the sixteenth preferred embodiment of the present disclosure.

FIG. 63 is a schematic view 2 of operation of the sixteenth preferred embodiment of the present disclosure.

FIG. 64 is a schematic view 1 of operation of the seventeenth preferred embodiment of the present disclosure.

FIG. 65 is a schematic view 2 of operation of the seventeenth preferred embodiment of the present disclosure.

FIG. 66 is a schematic view of operation of the eighteenth preferred embodiment of the present disclosure.

### DETAILED DESCRIPTION OF THE INVENTION

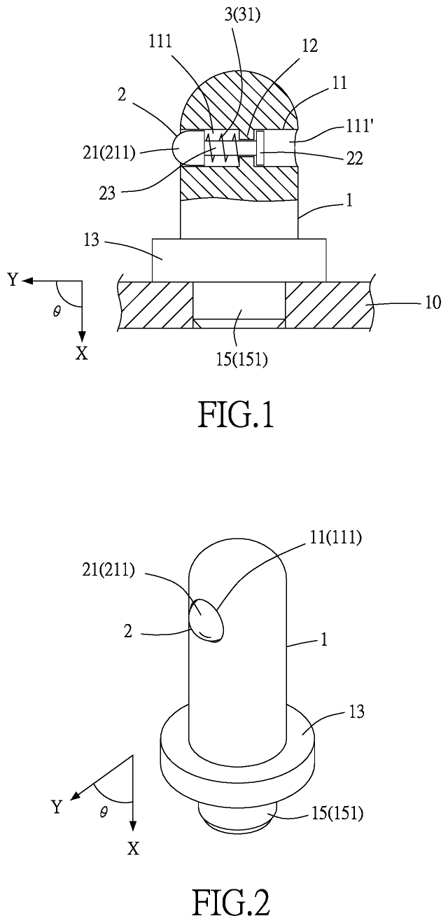

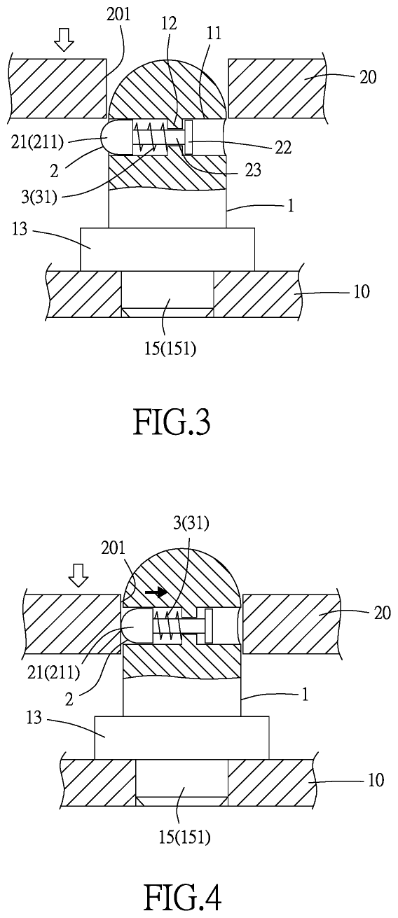

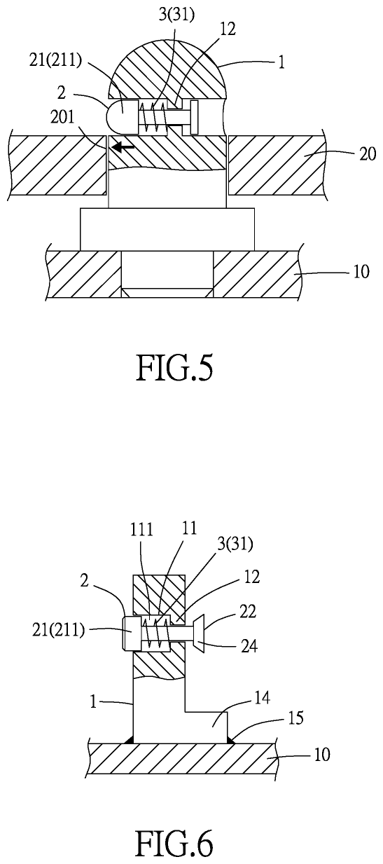

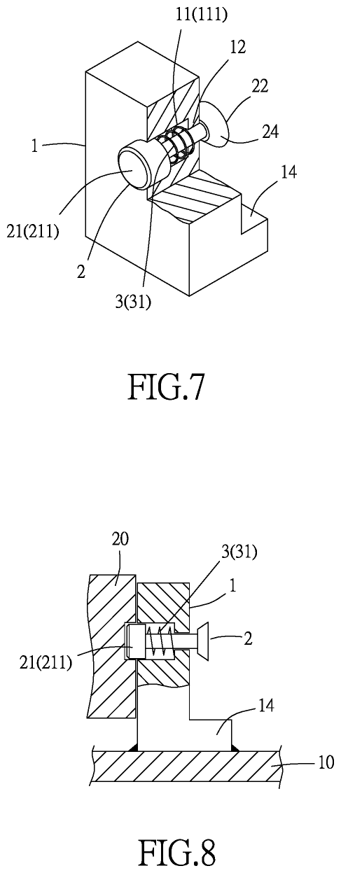

Referring to FIG. 1, FIG. 2, FIG. 6 and FIG. 7, the lateral positioning device of the present invention is adapted to be coupled to a first object 10 (such as a casing, a chassis, a board or a circuit board) and laterally or obliquely engaged with a second object 20 (such as any other casing, chassis, board or circuit board). In a preferred embodiment of the present invention, the lateral positioning device essentially comprises a body portion 1 and a positioning element 2 movable within the body portion 1. The body portion 1 is provided in the form of a post (a rod), a cylinder, a rod, a block, a plate (shown in FIG. 6 and FIG. 7), a hollowed-out structure, a bent structure, a polyhedral structure, an irregularly shaped solid structure, a handle structure or a latch structure. The body portion 1 is coupled to the first object 10 in a first direction X. The body portion 1 has at least one through hole 11 which extends in a second direction Y. The through hole 11 has therein a limiting portion 12. The limiting portion 12 is a radially limiting raised portion integrally formed or mounted at one end, or the middle, of the inner wall of the through hole 11. An angle θ is formed between the first direction X and the second direction Y. The angle θ is 30°˜150°, preferably 90°. The positioning element 1 is penetratingly disposed in the through hole 11 of the body portion 1 and axially or radially limited by the limiting portion 12 to allow the positioning element 1 to move in the second direction Y of the through hole 11. Preferably, the positioning element 2 has an engaging portion 21, a stopping portion 22, and a neck portion 23. The engaging portion 21 is disposed on a first side of the limiting portion 12. The engaging portion 21 has a larger diameter than the limiting portion 12. With the positioning element 2 being movable, the engaging portion 21 squarely engages (shown in FIG. 8) or laterally interferes (shown in FIG. 3 and FIG. 4) with the second object 20. The stopping portion 22 is disposed on a second side of the limiting portion 12. The stopping portion 22 has a larger diameter than the limiting portion 12 so as to be stopped at the limiting portion 12, thereby preventing the positioning element 2 from separating from the through hole 11. The neck portion 23 is integrally formed or mounted to be connected between the engaging portion 21 and the stopping portion 22 and passed through the limiting portion 12.

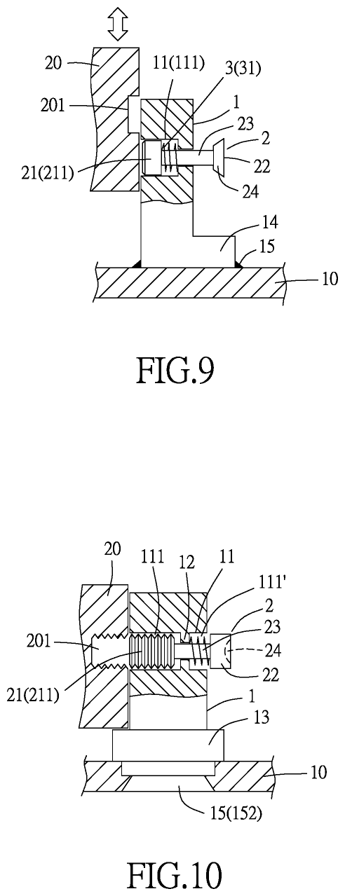

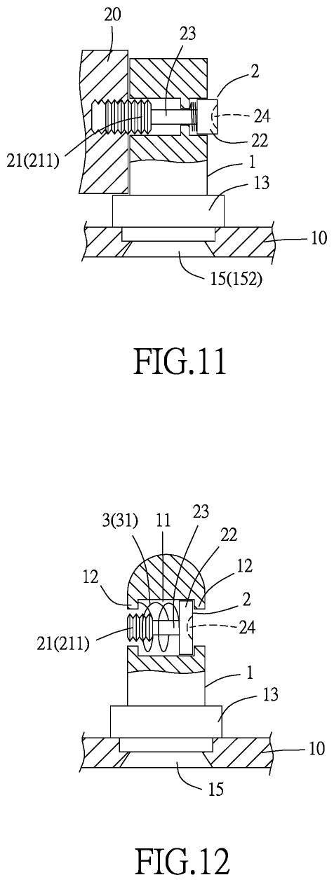

Referring to FIG. 3 and FIG. 4, to start operating the lateral positioning device of the present invention, the body portion 1 penetrates a hole 201 of the second object 20 so that the hole 201 compresses the positioning element 2. As a result, the engaging portion 21 retracts into the through hole 11 of the body portion 1. It is only when the engaging portion 21 passes through the hole 201 of the second object 20 that a resilient element 3 causes the positioning element 2 to rebound, and therefore the engaging portion 21 laterally interferes and engages with one end/side of the hole 201, thereby allowing the first object 10 and the second object 20 to engage with each other quickly. Referring to FIG. 8 and FIG. 9, to start operating the lateral positioning device of the present invention, it is feasible not to allow the body portion 1 to penetrate the second object 20 but to allow the second object 20 to abut against the body portion 1 laterally, and therefore a resilient thrust from the resilient element 3 causes the engaging portion 21 of the positioning element 2 to squarely engage with the hole 202 of the second object 20.

Referring to FIG. 1 and FIG. 2, in a preferred embodiment of the present invention, the body portion 1 has a shoulder 13 which abuts against the first object 10, or a base portion 14 is disposed on any one or two sides of the body portion 1 to abut against the first object 10 so that the body portion 1 is coupled to the first object 10 through the shoulder 13 or the base portion 14. Specifically speaking, the present invention is characterized in that a jointing portion 15 is disposed at any point on the shoulder 13 or the base portion 14 so that the jointing portion 15 is coupled to the first object 10 in the first direction X through a post-connecting structure 151 (shown in FIG. 1), a riveting structure 152 (shown in FIG. 10), a screwing structure, an expanding structure, a welding structure, a snap-engaging structure, an adhering structure, a magnetically attracting structure or an integrally formed structure; hence, the lateral positioning device of the present invention and the first object 10 together form a module which squarely engages or laterally interferes with the second object 20.

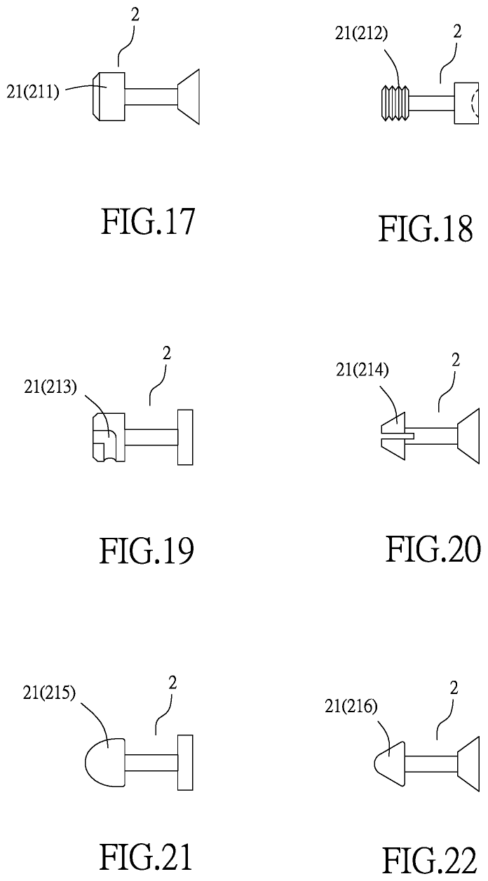

Through the engaging portion 21, the positioning element 2 squarely engages or laterally interferes with the second object 20. The engaging portion 21 is provided in the form of a post 211 (shown in FIG. 7, FIG. 8 and FIG. 17), a threaded structure 212 (shown in FIG. 10 and FIG. 18), a female engaging structure 213 (shown in FIG. 19), a resiliently engaging structure 214 (shown in FIG. 20), a spherical structure 215 (shown in FIG. 1 and FIG. 19), a male engaging structure, an arcuate-surfaced structure 216 (shown in FIG. 22) or an oblique-surfaced structure. The holes 201, 202 of the second object 20 come with the post 211, the threaded structure 212, the female engaging structure 213, the resiliently engaging structure 214, the spherical structure 215 or a male engaging structure and the arcuate-surfaced structure 216 so that the lateral positioning device of the present invention engages or interferes with the second object 20.

According to the present invention, the stopping portion 22 of the positioning element 2 is axially stopped at the limiting portion 12 of the through hole 11. The stopping portion 22 is disposed inside the through hole 11 (shown in FIG. 1 and FIG. 10) or outside the through hole 11 (shown in FIG. 7 and FIG. 8). An operating portion 25 is disposed on a lateral side or end surface of the stopping portion 22 so as to be easily pushed, pulled or twisted, and therefore the engaging portion 21 at the other end squarely engages or laterally interferes with the second object 20. The operating portion 25 has a color layer. The color layer is made of plastic, rubber, silica gel, lacquer, baking varnish or electroplated layer and serves a descriptive, indicative or distinctive purpose. The first side and/or the second side of the limiting portion 12 of the through hole 11 can form a retraction space 111, 111′. The retraction space 111, 111′ (or the through hole 11) is provided in the form of a cylindrical space, a hexahedral space, a conical space, an arcuate space, a stepped space, a chamber-style space, an open chamber-style space, a recess, an L-shaped chamber or a one-sided chamber so that the engaging portion 21 or the stopping portion 22 of the positioning element 2 is received or moves within the retraction space 111, 111′.

Referring to FIG. 12, according to the present invention, two limiting portions 24 are disposed on the inner wall of the through hole 11 of the body portion 1 or disposed at openings at two ends of the through hole 11 of the body portion 1, respectively, so that the positioning element 2 is received in the through hole 11 to allow the stopping portion 22 to be received between the limiting portions 24, thereby stopping the positioning element 2.

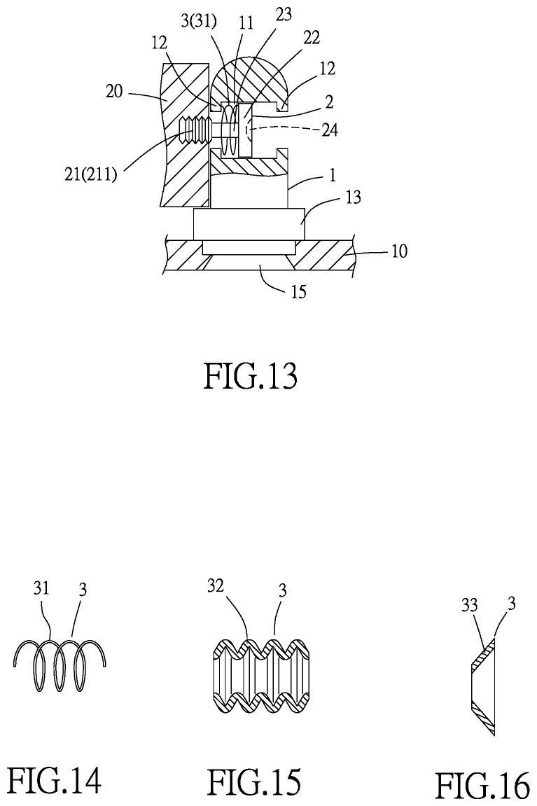

In another preferred embodiment of the present invention, to enable or disable square engagement or lateral interference between the engaging portion 21 of the positioning element 2 and the holes 201, 202 of the second object 20, the resilient element 3 is disposed in the retraction space 111 on the first side of the limiting portion 12 to allow one end of the resilient element 3 to abut against the engaging portion 21 and allow the other end of the resilient element 3 to abut against the limiting portion 12 (shown in FIG. 1, FIG. 6 and FIG. 7) (or the body portion 1), thereby assisting the engaging portion 21 in squarely engaging or laterally interfering with the holes 201, 202 of the second object 20. Alternatively, the resilient element 3 is disposed in the retraction space 111′ on the first side of the limiting portion 12 to allow one end of the resilient element 3 to abut against the stopping portion 22 and allow the other end of the resilient element 3 to abut against the limiting portion 12 (or the body portion 1), thereby disabling the square engagement or lateral interference between the engaging portion 21 and the second object 20 (as shown in FIG. 10). Referring to FIG. 13, the resilient element 3 is disposed in the through hole 11 to allow one end of the resilient element 3 to abut against the body portion 1 or any one of the limiting portions 24 and allow the other end of the resilient element 3 to abut against the stopping portion 22. Preferably, the resilient element 3 is provided in the form of a helical spring 31 (shown in FIG. 1 and FIG. 14), a resilient post 32 (shown in FIG. 15) or a leaf spring 33 (shown in FIG. 16).

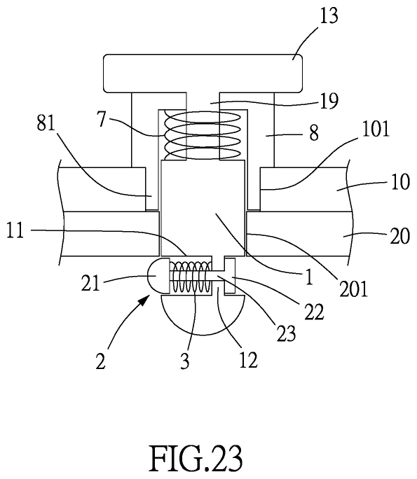

Referring to FIG. 23, the body portion 1 is adapted to be coupled to the first object 10 in the first direction through a sleeve 8. The sleeve 8 has a jointing portion 81 which is coupled to a fixing hole 101 of the first object 10. The sleeve 8 is movably disposed at the body portion 1. The sleeve 8 movably fits around a neck portion 19 of the body portion 1 so that the sleeve 8 is confined to between the shoulder 13 and the body portion 1. A resilient element 7 is disposed between the sleeve 8 and the body portion 1 to allow the sleeve 8 to move resiliently relative to the body portion 1.

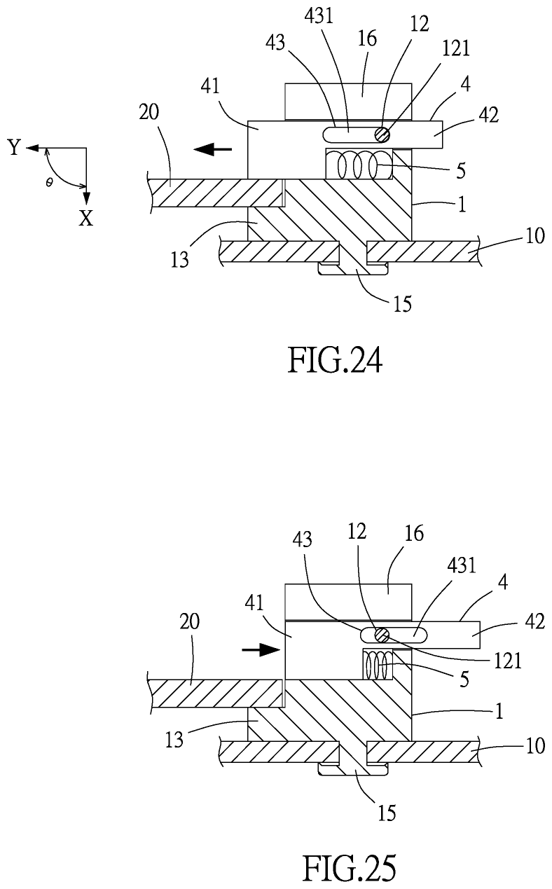

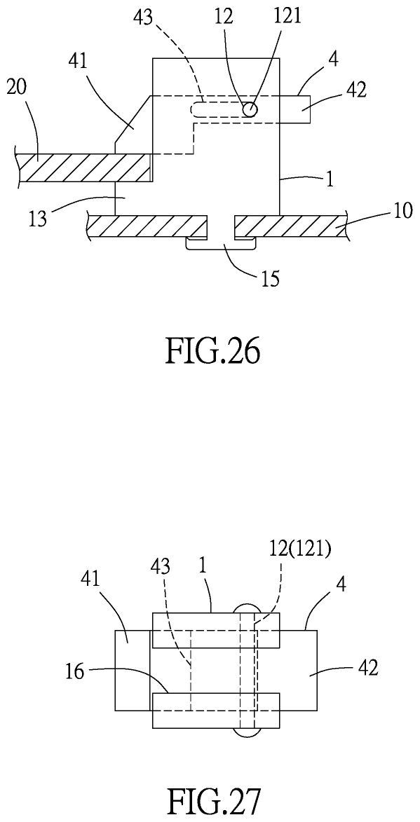

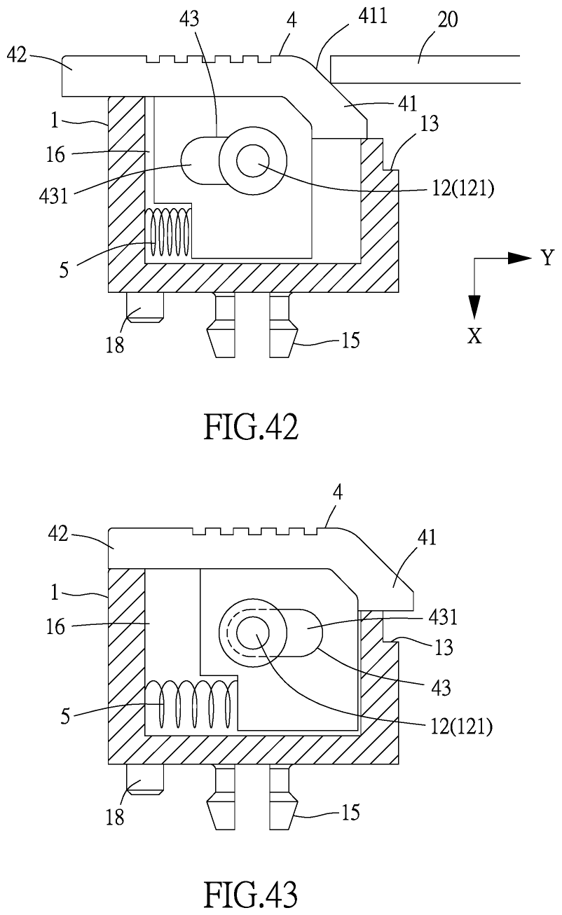

Referring to FIG. 24, FIG. 25, FIG. 26, FIG. 27, FIG. 42 and FIG. 43, in the fifth preferred embodiment of the present invention, the lateral positioning device essentially comprises a body portion 1 and a movement element 4. The body portion 1 is made of a plastic or a metal. The body portion 1 is adapted to be coupled to the first object 10 in the first direction X. The body portion 1 has at least one chamber portion 16 which extends in the second direction Y. An angle θ is formed between the first direction X and the second direction Y. The angle θ is preferably 15° to 165°. The chamber portion 16 is a through hole, a recess, an L-shaped chamber or a one-sided chamber. Likewise, the chamber portion 16 has therein a limiting portion 12. The movement element 4 is penetratingly disposed in the chamber portion 16. The movement element 4 is limited by the limiting portion 12 and thereby moves in the second direction Y. The movement element 4 engages or interferes with a second object 20. The first object 10 and the second object 20 are made of a plastic or a metal and are each a board, a block, a post or a structure of any other shape which is made of any other material.

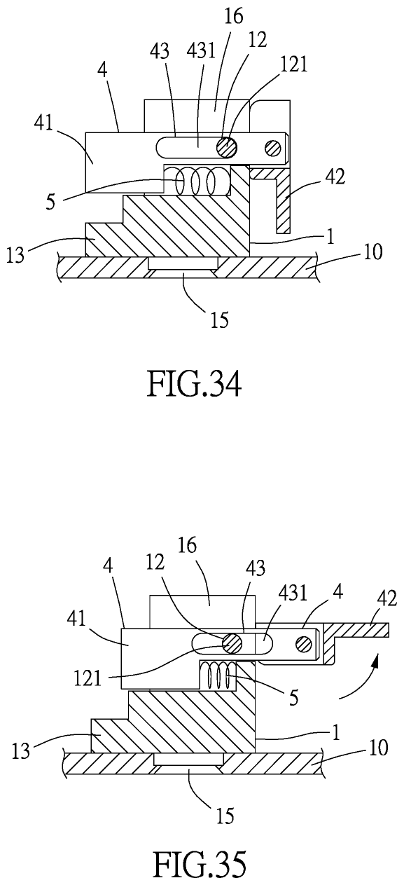

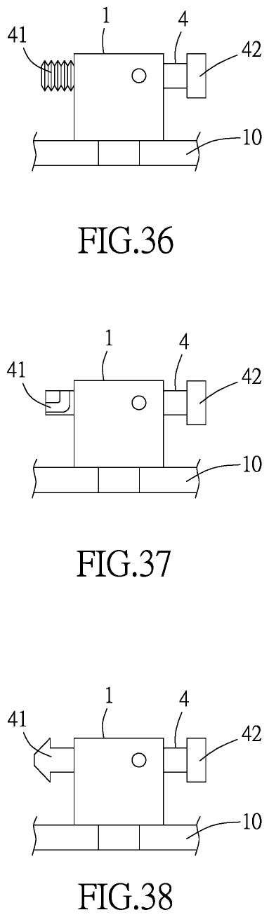

Referring to FIG. 24 through FIG. 27, the movement element 4 has at one end thereof an engaging portion 41. The engaging portion 41 engages or interferes with the second object 20. The engaging portion 41 is a post (shown in FIG. 24), an oblique-surfaced structure (shown in FIG. 26 and FIG. 42), a threaded structure (shown in 36), a female engaging structure (shown in FIG. 37), a resiliently engaging structure, a spherical structure, a male engaging structure (shown in FIG. 38) or an arcuate-surfaced structure and engages or interferes with the second object 20 structurally corresponding to the engaging portion 41. The movement element 4 has at the other end thereof an operating portion 42 for moving the movement element 4. The operating portion 42 is disposed inside or outside the chamber portion 16. The operating portion 42 is provided in the form of a post-shaped, sheet-shaped, convex, concave, arcuate, spherical, taper, handle-shaped or movable board (shown in FIG. 34 and FIG. 35). The operating portion 42 has a color layer. The color layer is made of plastic, rubber, silica gel, lacquer, baking varnish or electroplated layer.

The movement element 4 has a convex structure, a concave structure or a stepped anti-skid structure. Alternatively, the movement element 4 has an operating portion 42, and the operating portion 42 is a convex structure, a concave structure or a stepped anti-skid structure. Alternatively, the operating portion 42 is a wing-shaped structure, a hook-shaped structure, a post-shaped structure, an arcuate structure, an oblique surface structure, a stepped structure or a planar structure.

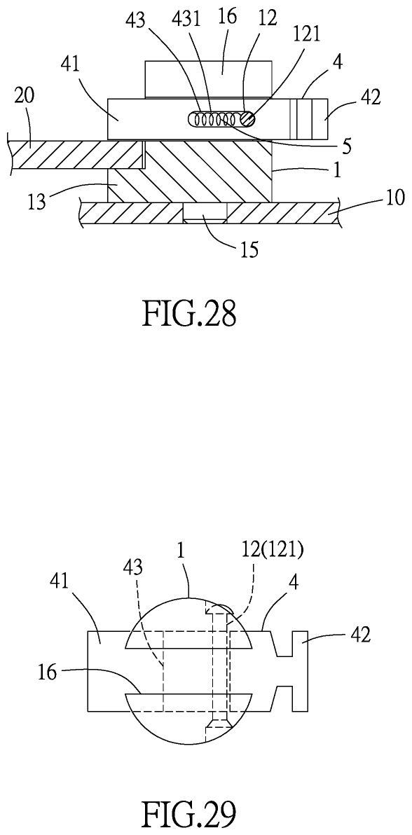

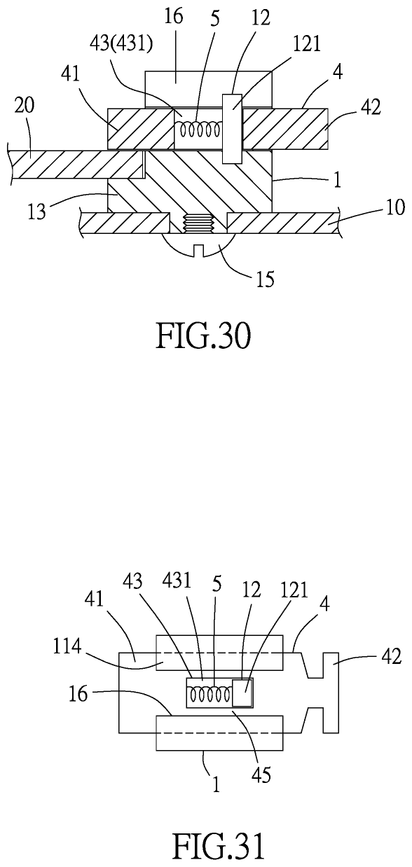

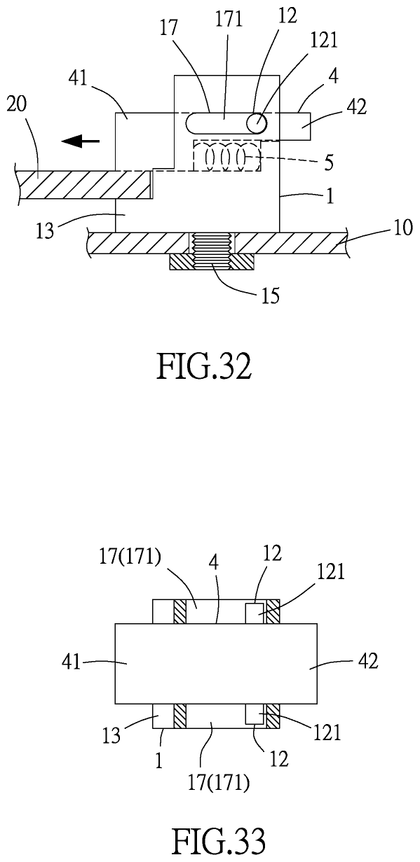

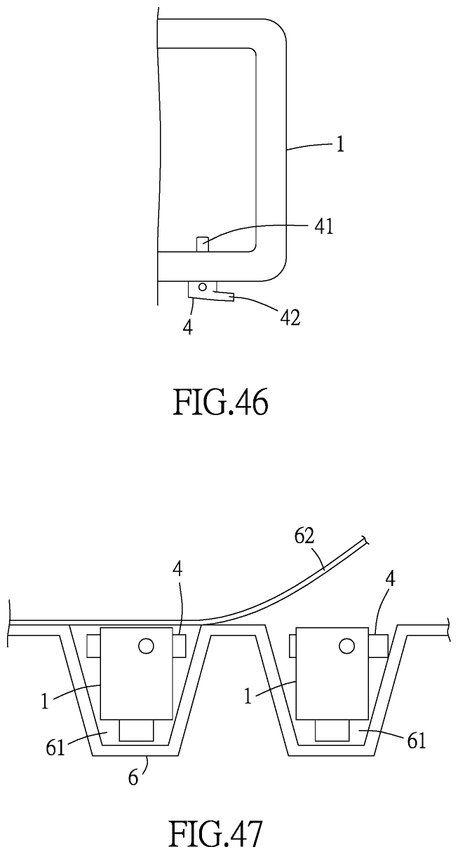

Referring to FIG. 24 and FIG. 25, the body portion 1 is a post, a cylinder (shown in FIG. 28 and FIG. 29), a rod, a block (shown in FIG. 42 through FIG. 44), a plate, a hollowed-out structure, a bent structure, a polyhedral structure, an irregularly shaped solid structure, a handle structure (shown in FIG. 46) or a latch structure. The body portion 1 has the shoulder 13 which abuts against the first object 10 or second object 20. The body portion 1 has a jointing portion 15. The jointing portion 15 is adapted to be coupled to the first object 10 in the first direction X through a post-connecting structure (shown in FIG. 28), a riveting structure (shown in FIG. 34 and FIG. 35), a screwing structure (shown in FIG. 30 and FIG. 32), an expanding structure, a welding structure, a snap-engaging structure (shown in FIG. 24, FIG. 25, FIG. 26, FIG. 42 and FIG. 43), an adhering structure, a magnetically attracting structure or an integrally formed structure so that the lateral positioning device of the present invention and the first object 10 together form a module. Referring to FIG. 42 and FIG. 43, the body portion 1 has a positioning portion 18. The positioning portion 18 and the jointing portion 15 are jointly mounted on the first object 10 so as to form a module, to allow the body portion 1 to be positioned at the positioning portion 18 when joined to the first object 10 by the jointing portion 15, such that the body portion 1 has two transverse limiting structures, namely the jointing portion 15 and the positioning portion 18, for preventing rotation of the body portion 1.

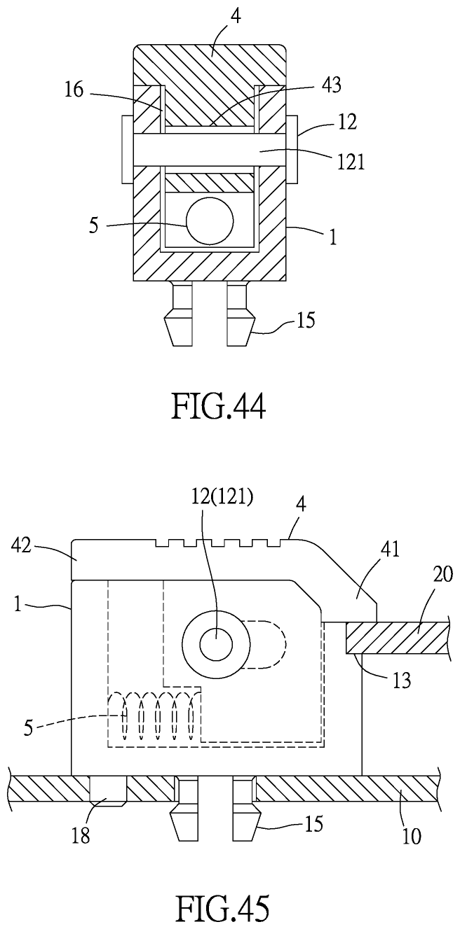

Referring to FIG. 24, FIG. 28, FIG. 42 and FIG. 43, the movement element 4 (or body portion 1) has a movement opening 43. The movement opening 43 is a through hole, a recess, an oblong slot or an oblong hole so that the limiting portion 12 is confined to the movement opening 43 of the movement element 4 to allow the movement element 4 to move within a movement limiting space 431 of the movement opening 43, so as to catch or release the second object 20 (such as FIG. 45). The limiting portion 12 is a penetratingly disposing element 121. The penetratingly disposing element 121 is integrally formed of a post (such as FIG. 44), an engaging structure or a plate and the body portion 1 or the movement element 4 so that the penetratingly disposing element 121 movably penetratingly disposed or fixedly penetratingly disposed in the movement opening 43 of the movement element 4. Referring to FIG. 24 through FIG. 29, and FIG. 44, the penetratingly disposing element 121 is coupled to the body portion 1 in a manner to not only allow the penetratingly disposing element 121 to be perpendicular to the axis of the body portion 1 but also allow the penetratingly disposing element 121 to be penetratingly disposed in the movement opening 43. Referring to FIG. 30 and FIG. 31, the penetratingly disposing element 121 is coupled to the body portion 1 in a manner to not only allow the penetratingly disposing element 121 to be parallel to the axis of the body portion 1 but also allow the penetratingly disposing element 121 to be penetratingly disposed in the movement opening 43.

Referring to FIG. 32 and FIG. 33, in a preferred embodiment of the present invention, the body portion 1 has at least one body portion opening 17. The at least one body portion opening 17 is disposed on two sidewalls of the chamber portion 16, respectively. The body portion opening 17 is a through hole, a recess, an oblong slot or an oblong hole; hence, the limiting portion 12 is confined to the body portion opening 17 of the body portion 1 to allow the movement element 4 to move within a movement limiting space 171 of the body portion opening 17, thereby allowing the engaging portion 41 of the movement element 4 to catch or release the second object 20. Referring to FIG. 32 and FIG. 33, the limiting portion 12 is a penetratingly disposing element 121. The penetratingly disposing element 121 is integrally formed of a post, an engaging structure or a plate and the body portion 1 or the movement element 4 to not only allow the penetratingly disposing element 121 to be coupled to one or two sides of the movement element 4 but also allow the penetratingly disposing element 121 to be penetratingly disposed in the body portion opening 17.

Referring to FIG. 24, FIG. 28, FIG. 30, FIG. 32, FIG. 33, FIG. 42 and FIG. 43, a resilient element 5 is provided in the second preferred embodiment of the present invention. The resilient element 5 is a spring, a leaf spring, a resilient post or a resilient body. The resilient element 5 is abuttingly disposed between the movement element 4 and the limiting portion 12 (shown in FIG. 28) or abuttingly disposed between the movement element 4 and the body portion 1 (shown in FIG. 24) so that the resilience of the resilient element 5 assists the engaging portion 41 of the movement element 4 in catching or releasing the second object 20. The movement element 4 has a convoluted surface.

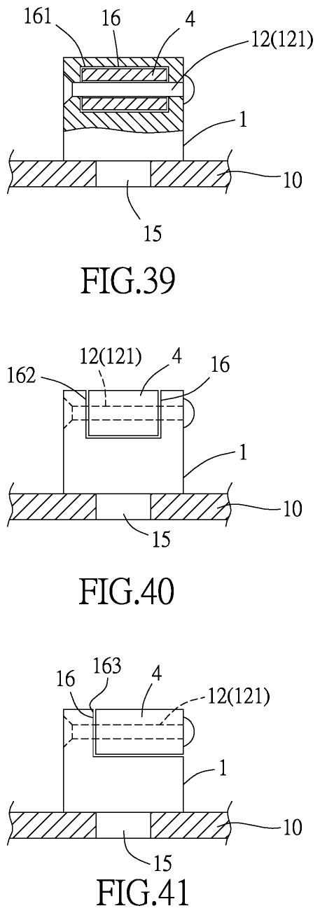

Referring to FIG. 39, according to the present invention, the chamber portion 16 of the body portion 1 penetrates a through hole or a penetrating opening of the body portion 1 to allow the movement element 4 to be penetratingly disposed in the through hole or a penetrating opening 161. Referring to FIG. 40, FIG. 42 through FIG. 44, the chamber portion 16 of the body portion 1 bulges inward into a recess 162 at one end or on one side of the body portion 1 to allow the movement element 4 to be penetratingly disposed in the recess 162. Referring to FIG. 41, the chamber portion 16 of the body portion 1 bulges inward into an L-shaped chamber 163 or a one-sided chamber on one side of the body portion 1 to allow the movement element 4 to be penetratingly disposed in the L-shaped chamber 163 or the one-sided chamber.

Referring to FIG. 42, one end of the movement element 4 has an engaging portion 41. One end of the engaging portion 41 has a guidance portion 411. The guidance portion 411 is an oblique surface, an arcuate surface, a curved surface or a step surface. The second object 20 presses against the guidance portion 411 and then pushes the movement element 4. After the second object 20 has moved to the shoulder 13, the engaging portion 41 engages with the second object 20 such that the second object 20 is coupled to between the engaging portion 41 and the shoulder 13.

Referring to FIG. 47, a carrier 6 is further provided in a preferred embodiment of the present invention. The carrier 6 carries the lateral positioning device. The carrier 6 is provided in the form of a feed pan or a feed belt and has at least one receiving portion 61. The lateral positioning device is received in the receiving portion 61. The carrier 6 has a lid 62 for covering the receiving portion 61 and the lateral positioning device to prevent the lateral positioning device from falling off the carrier 6.

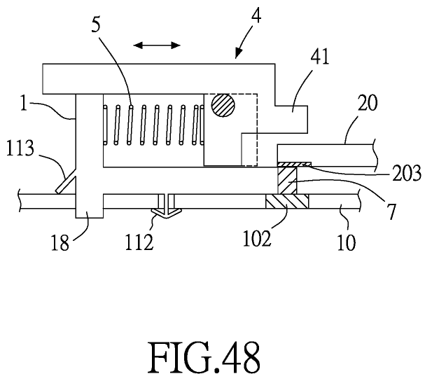

Referring to FIG. 48, in a preferred embodiment of the present disclosure, the first object 10 and the second object 20 are printed circuit boards (PCB). The first object 10 and the second object 20 have conduction circuit points 102, 203 connected to a conduction circuit portion 7, respectively. Alternatively, the lateral positioning device has a conduction circuit point, not shown). The body portion 1 has a blocking-engaging portion 112 and at least one resilient opposing portion 113.

To operate the lateral positioning device, the user mounts the lateral positioning device on the first object 10 while the blocking-engaging portion 112 is being coupled to the first object 10 and the resilient opposing portion 113 is resiliently opposing the first object 10 such that the first object 10 is resiliently engaged between the blocking-engaging portion 112 and the resilient opposing portion 113 and positioned by the positioning portion 18; hence, the body portion 1 is fixedly disposed on the first object 10. Afterward, the user moves the movement element 4 such that the engaging portion 41 thereof laterally engages with or interferes with the second object 20. When the movement element 4 moves, the guide portion 44 subsidiarily guides the resilient element 5 in performing lateral guidance movement while moving. After the first object 10 and the second object 20 have been mounted in place, the conduction circuit point 102 of the first object 10 and the conduction circuit point 203 of the second object 20 are electrically connected to the conduction circuit portion 7 to guide an electric charge or an electric current by the conduction circuit portion 7 and the conduction circuit point 102, 203.

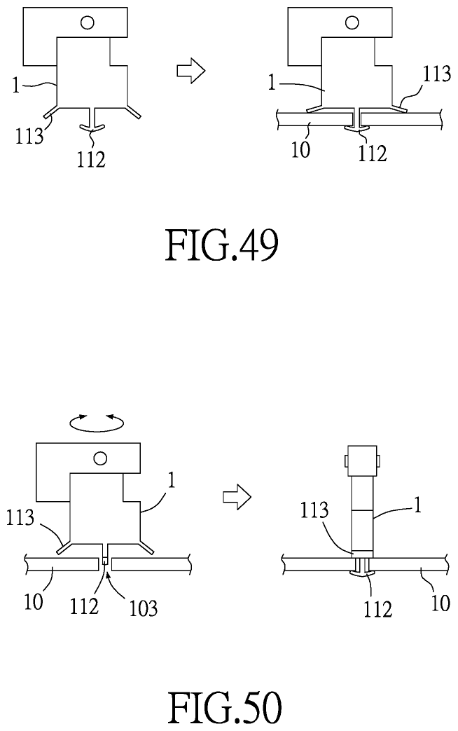

Referring to FIG. 49, in a preferred embodiment of the present disclosure, the blocking-engaging portion 112 and the resilient opposing portion 113 face the same opposing direction (i.e., 180 degrees relative to the body portion 1). To mount the body portion 1 in place, the user directly couples the blocking-engaging portion 112 to the first object 10 and ensures that the resilient opposing portion 113 resiliently opposes the first object 10 such that the first object 10 is resiliently engaged between the blocking-engaging portion 112 and the resilient opposing portion 113.

Referring to FIG. 50, in a preferred embodiment of the present disclosure, the blocking-engaging portion 112 and the resilient opposing portion 113 face different directions relative to each other (the blocking-engaging portion 112 faces a direction which is 90 degrees relative to the body portion 1, and the resilient opposing portion 113 faces a direction which is 180 degrees relative to the body portion 1). In order for the body portion 1 to be mounted in place, the blocking-engaging portion 112 penetrates a joined portion 103 of the first object 10, and then the body portion 1 is rotated by 5 degrees ˜355 degrees to thereby interfere with or engage with the first object 10, thereby allowing the first object 10 to be resiliently engaged between the blocking-engaging portion 112 and the resilient opposing portion 113.

Referring to FIG. 48 and FIG. 50, the blocking-engaging portion 112 is an engaging plate larger than the joined portion 103 of the first object 10 such that the engaging plate resiliently contracts when penetrating the first object 10 and then expands to engage with the first object 10.

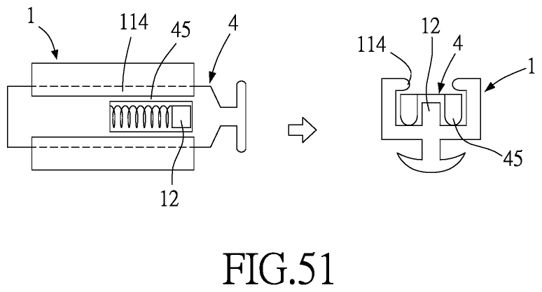

Referring to FIG. 51, in a preferred embodiment of the present disclosure, two sides of the body portion 1 each have a corresponding engaging surface 114, whereas two sides of the movement element 4 each have an engaging surface 45. The engaging surfaces 45 are engaged with the corresponding engaging surfaces 114 and the engaging surfaces 45 are limited by the limiting portion 12 such that the body portion 1 and the movement element 4 are movably joined together.

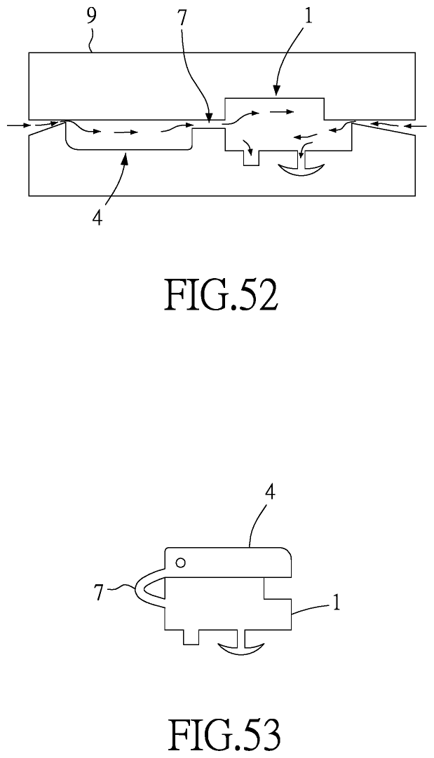

Referring to FIG. 52 and FIG. 53, in a preferred embodiment of the present disclosure, the body portion 1 and the movement element 4 are connected by a fastening portion 7 or are integrally formed. When the body portion 1 and the movement element 4 are connected by the fastening portion 7 or are integrally formed, the body portion 1 and the movement element 4 are formed by solidification of a liquid raw material introduced into a mold 9 by in-mold injection. In addition, the fastening portion 7 can be bent to assemble the body portion 1 and the movement element 4.

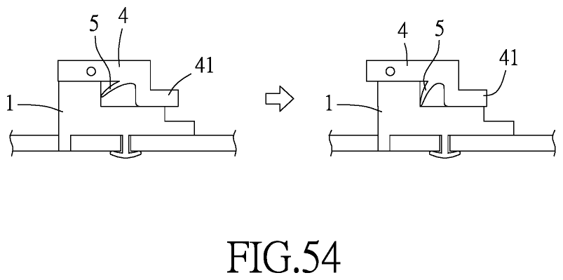

Referring to FIG. 54, in a preferred embodiment of the present disclosure, the resilient element 5 is integrally formed with the body portion 1 or the movement element 4. The integrally-formed resilient element 5 is formed by solidification of a liquid raw material introduced into a mold 9 by plastic in-mold injection. In this embodiment, the resilient element 5 is integrally formed with the movement element 4. Therefore, when the lateral positioning device is in operation, the resilient element 5 enables the engaging portion 41 of the movement element 4 to laterally engage with or interfere with the second object (not shown). In order for the second object to separate from the engaging portion 41 of the movement element 4, the movement element 4 is moved such that not only does the engaging portion 41 separate from the second object, but the resilient element 5 is also compressed. After the second object has separated from the engaging portion 41, the movement element 4 is released; owing to the resilient release of the resilient element 5, the movement element 4 moves and returns to its initial position, so as to become available for the next instance of use.

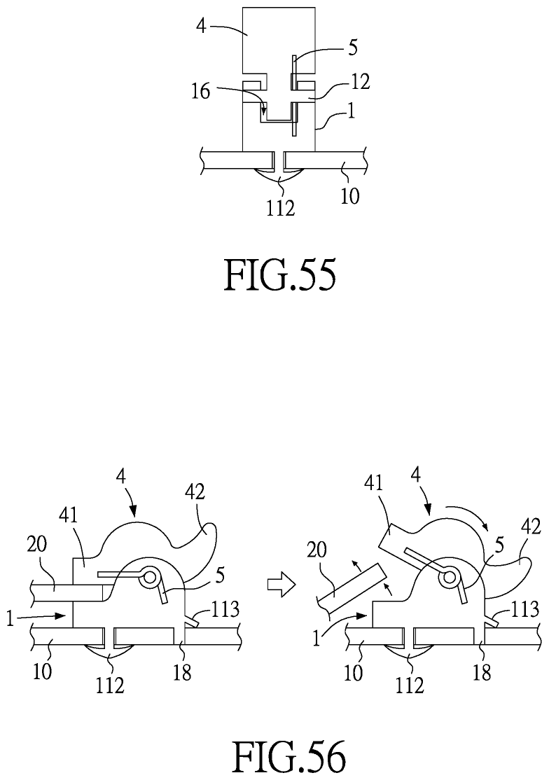

Referring to FIG. 55 and FIG. 56, in a preferred embodiment of the present disclosure, the movement element 4 is rotatably disposed at the chamber portion 16 because of the limiting portion 12. The limiting portion 12 has a resilient element 5. The two ends of the resilient element 5 abut against the body portion 1 and the movement element 4, respectively. Therefore, after the positioning portion 18 of the body portion 1 has been disposed on the first object 10 in conjunction with the blocking-engaging portion 112 and the resilient opposing portion 113, the user presses the operating portion 42 of the movement element 4 and thus compresses the resilient element 5 to allow the movement element 4 to rotate relative to the body portion 1; after the second object 20 has been placed at a position corresponding to that of the engaging portion 41, the operating portion 42 is released such that the resilient element 5 is resiliently released, thereby allowing the engaging portion 41 of the movement element 4 to rotate and engage with the second object 20. Therefore, the lateral positioning device of the present disclosure is capable of rotational engagement and thus meets practical needs.

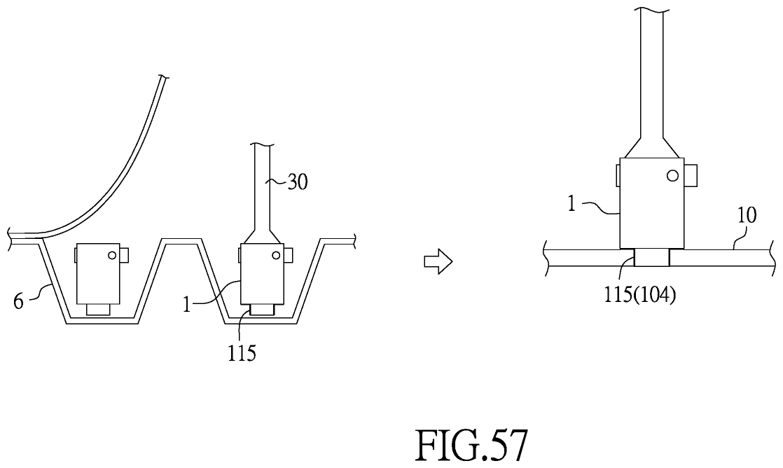

Referring to FIG. 57, in a preferred embodiment of the present disclosure, the body portion 1 has a weldable surface 115 whereby the body portion 1 is taken out of a carrier 6 by a vacuum suction tool 30 or a related tool and then placed on the weldable surface 104 of the first object 10 (or the second object 20) such that the weldable surface 115 of the body portion 1 and the weldable surface 104 of the first object 10 (or the second object 20) are welded together.

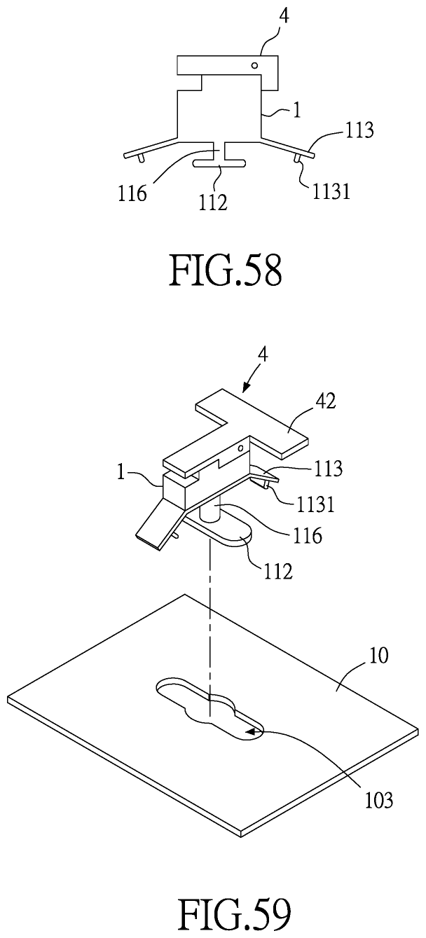

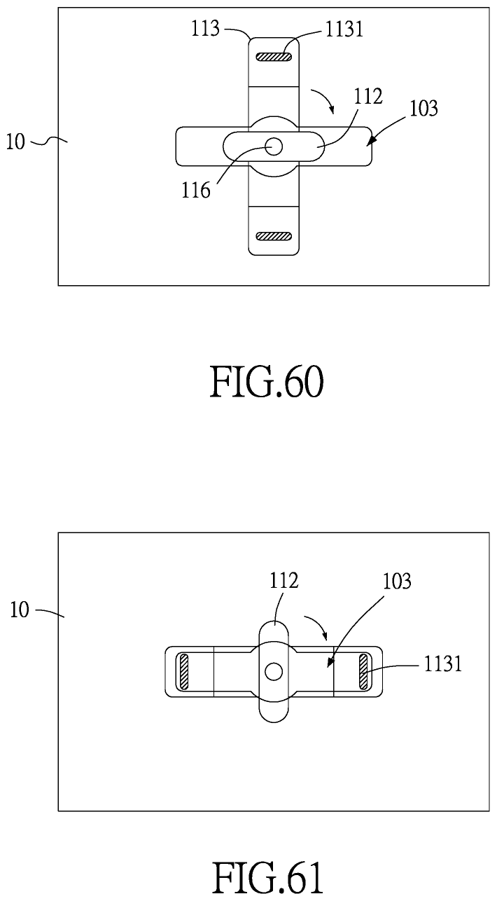

Referring to FIG. 58 through FIG. 63, in a preferred embodiment of the present disclosure, the body portion 1 has an axial portion 116, a blocking-engaging portion 112 and two resilient opposing portions 113. The axial portion 116 is disposed on the bottom surface of the body portion 1. The blocking-engaging portion 112 is connected to the axial portion 116. The resilient opposing portions 113 are disposed on two lower sides of the body portion 1, respectively. An engaging convex portion 1131 is disposed on each of the bottom surfaces of the resilient opposing portions 113. The blocking-engaging portion 112 and the resilient opposing portions 113 face different directions relative to each other (the blocking-engaging portion 112 faces a direction which is 90 degrees relative to the body portion 1, and the resilient opposing portions 113 faces a direction which is 180 degrees relative to the body portion 1). The joined portion 103 of the first object 10 is a wide-hole portion. The wide portion of the axial portion 116 is smaller than the wide side of the blocking-engaging portion 112 and smaller than the joined portion 103 or the wide-hole portion of the first object 10. In order for the body portion 1 to be mounted in place, the blocking-engaging portion 112 penetrates the joined portion 103 of the first object 10 such that the wide side of the blocking-engaging portion 112 penetrates the first object 10 from the wide side of the wide-hole portion (meanwhile, the axial portion 116 is disposed in the joined portion 103.) Afterward, the body portion 1 is rotated; hence, the wide side of the blocking-engaging portion 112 rotates to the non-wide side position smaller than the wide-hole portion to effectuate opposition, and the resilient opposing portions 113 rotates from the non-wide side or the wide side of the wide-hole portion to the wide side or the non-wide side of the wide-hole portion so as to oppose the surface of the first object 10 and allow the engaging convex portions 1131 to rotate from the non-wide side or the wide side of the wide-hole portion to the wide side or the non-wide side of the wide-hole portion so as to oppose the wide-hole portion from inside or outside and limit positions of the resilient opposing portions 113, thereby engaging with the joined portion 103 of the first object 10 and causing the first object 10 to be engaged between the blocking-engaging portion 112 and the resilient opposing portions 113.

The operating portion 42 of the movement element 4 is a wing-shaped structure, so as to meet practical needs (as shown in FIG. 59.)

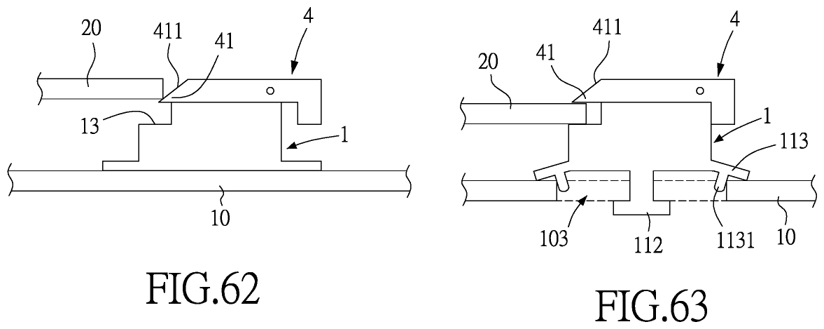

One end of the movement element 4 has an engaging portion 41. One end of the engaging portion 41 has a guidance portion 411. The guidance portion 411 is an oblique surface, an arcuate surface, a curved surface or a step surface. The second object 20 presses against the guidance portion 411 and then pushes the movement element 4. After the second object 20 has moved to the shoulder 13, the engaging portion 41 engages with the second object 20 such that the second object 20 is coupled to between the engaging portion 41 and the shoulder 13 (as shown in FIG. 62 and FIG. 63.)

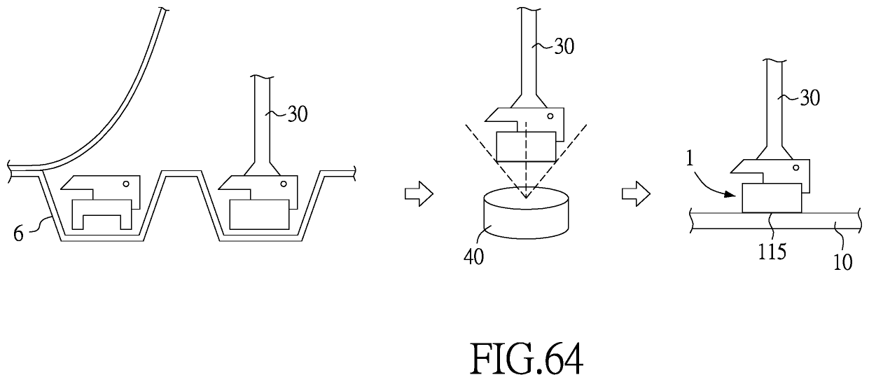

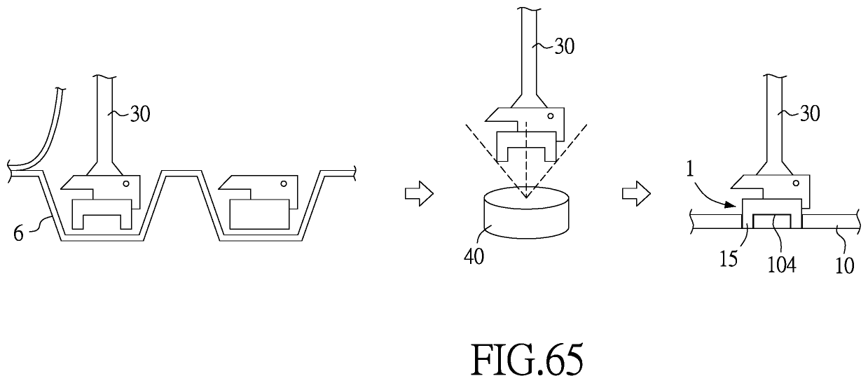

Referring to FIG. 64 and FIG. 65, in a preferred embodiment of the present disclosure, the lateral positioning device is carried by a carrier 6 and taken out thereof by a tool 30 before being compared by a comparison device 40 to compare or calculate a relative or absolute position and distance between the lateral positioning device and the first object 10 and then provide the tool 30 with related information to allow the tool 30 to place the lateral positioning device at a target position on the first object 10 (PCB) precisely; hence, the weldable surface 115 of the jointing portion 15 of the body portion 1 is welded to the first object 10, or the jointing portion 15 is inserted into the first object 10 such that the weldable surface 115 of the jointing portion 15 of the body portion 1 is welded to the weldable surface 104 of the first object 10.

The tool 30 is a vacuum sucker, a magnetic sucker or a clamp. The comparison device 40 is a visual comparison device, an image comparison device or a distance calculating device. The first object 10 is a printed circuit board (PCB), a metal plate or a plastic plate.

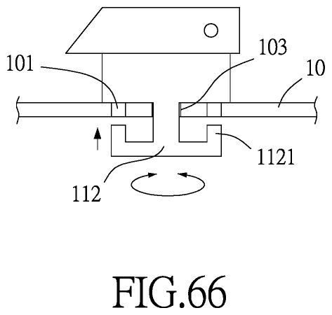

Referring to FIG. 66, in a preferred embodiment of the present disclosure, the joined portion 103 of the first object 10 is a wide-hole portion, and the blocking-engaging portion 112 has a convex engaging portion 1121. The convex engaging portion 1121 rotates from the non-wide side or the wide side of the wide-hole portion to the wide side or the non-wide side of the wide-hole portion so as to oppose the fixing hole 101 inside or outside the wide-hole portion, thereby limiting the position of the blocking-engaging portion 112.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A lateral positioning device, comprising:
a body portion having a limiting portion, the body portion is coupled to a first object in a first direction; and
a movement element limited by the limiting portion and rotatably connected to the body portion, the movement element engages with a second object in a second direction, an angle is formed between the first direction and the second direction.

2. The lateral positioning device of claim 1, wherein the body portion has a chamber portion which has therein the limiting portion, the movement element is disposed in the chamber portion.

3. The lateral positioning device of claim 1, wherein the body portion has a blocking-engaging portion and at least one resilient opposing portion, the blocking-engaging portion is coupled to the first object, the resilient opposing portion resiliently opposes the first object such that the first object is resiliently engaged between the blocking-engaging portion and the resilient opposing portion.

4. The lateral positioning device of claim 1, wherein the limiting portion has a resilient element with two ends abutting against the body portion and the movement element, respectively.

5. The lateral positioning device of claim 1, wherein the body portion has a positioning portion positioned at the first object.
